(19) United States
(12) Patent Application Publication
(10) Pub. No.: US 2007/0157673 A1
(43) Pub. Date: Jul. 12, 2007

(54) Method for fabricating optical fiber preform and method for fabricating optical fiber using the same

(75) Inventors: Myung-Hwan Pyo, Gumi-si (KR); Jin-Seong Yang, Gumi-si (KR); Mun-Hyun Do, Chilgok-gun (KR); Jin-Han Kim, Suseong-gu (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/583,270

(22) Filed: Oct. 19, 2006

(30) Foreign Application Priority Data
Jan. 10, 2006 (KR) 2740/2006

(51) Int. Cl. C03B 37/07; C03B 37/018; C03B 37/01

(52) U.S. Cl. 65/377; 65/414; 65/426; 65/427

(57) ABSTRACT

Disclosed are a method for fabricating an optical fiber preform and a method for fabricating an optical fiber using the optical fiber preform. The method for fabricating the optical fiber preform including the steps of: (a) growing a first soot preform on a starting member by a soot deposition; (b) dehydrating the first soot preform; (c) sintering the first dehydrated soot preform to obtain a first glassed optical fiber perform; (e) growing an over-clad soot layer on the first optical fiber preform by soot deposition to obtain a second soot preform; and (f) sintering the second soot preform so as to obtain a second optical fiber preform which is glassed, wherein an average density of the first soot preform is substantially within a range of 0.19˜0.30 g/cc, and the average density of the over-clad soot layer is substantially within a range of 0.5˜0.75 g/cc.

### CLAIM OF PRIORITY

This application claims priority to application entitled “Method For Fabricating Optical Fiber Preform And Method For Fabricating Optical Fiber Using the Same,” filed with the Korean Intellectual Property Office on Jan. 10, 2006 and assigned Serial No. 2006-2740, the contents of which are incorporated herein by reference.

### BACKGROUND OF THE INVENTION

1. Field of the Invention

The present invention relates to a method for fabricating an optical fiber preform, and more particularly to a method for fabricating an optical fiber preform using a soot deposition.

2. Description of the Related Art

Methods for fabricating optical fiber preforms include a Modified Chemical Vapor Deposition (MCVD), a Vapor Axial Deposition (VAD), an Outside Vapor Deposition (OVD), and a Plasma Chemical Vapor Deposition (PCVD), etc.

According to the MCVD method, a source material and oxidation gas are supplied into a quartz tube while heating a peripheral surface of the quartz tube. Consequently, soot is created in the quartz tube. Then, this soot is deposited on an inner surface of the quartz tube.

The PCVD method is similar to the MCVD method, except that a microwave resonator is used.

According to the VAD and the OVD methods, a source material and fuel gas, etc. are supplied to a burner, so that soot is created by flame hydrolysis. Then, this soot is deposited on a starting member. In the VAD method, a soot preform is grown from an end portion of the starting member along a lengthwise direction of the starting member. In the OVD method, a soot preform is radially grown on the starting member.

The MCVD and PCVD methods use a high purity quartz tube. The quartz tube must be made in advance, and the source material used therein is expensive. Thus, the cost of manufacturing the soot preform increases. In the MCVD and PCVD methods, a method of over-cladding a quartz tube with a high purity is used to increase the diameter of the fabricated optical fiber preform. However, it is difficult to fabricate the optical fiber preform with a large diameter. The over-cladding method further increases the cost of fabricating the optical fiber preform. In addition, it is difficult to fabricate a low water peak optical fiber using the over-cladding method, since this method has a higher loss of OH radical absorption with relation to the light with a wavelength of 1383 nm when compared to the others.

In the VAD method, it's possible to fabricate a low water peak optical fiber having excellent quality and low cost. However, a soot preform fabricated by the VAD has a low average density. So, when the diameter of the soot preform is increased, the overall strength is lowered and soot preform is more fragile.

In the OVD method, moisture in a core of a soot preform has a great effect on loss of OH radical absorption with respect to light with a wavelength of 1383 nm. It is difficult to remove moisture from the core of the soot preform, thereby making it difficult to stably fabricate a low water peak optical fiber. However, the soot preform fabricated by the OVD method has a higher average density than that of the soot preform produced by the VAD method.

In the conventional methods for fabricating optical fiber preforms, it is difficult to remove moisture in the soot preform. Further, breakage of the soot preform frequently occurs, thereby making it difficult to stably mass-produce a low water peak optical fiber.

### SUMMARY OF THE INVENTION

Accordingly, the present invention has been made to solve the above-mentioned problems occurring in the prior art. One object of the present invention is to provide a method for fabricating an optical fiber preform and a method for fabricating an optical fiber using the same, which can effectively dehydrate moisture in a soot preform, and minimize breakage of the soot perform.

According to the principles of the present invention, a method for fabricating an optical fiber preform is provided. The method includes the steps of: (a) growing a first soot preform on a starting member by a soot deposition; (b) dehydrating the first soot preform; and (c) sintering the first dehydrated soot preform to obtain a first glassed optical fiber perform, wherein an average density of the first soot preform is substantially within a range of 0.19˜0.30 g/cc.

According to another embodiment of the present invention, a method for fabricating an optical fiber preform is provided, which includes the steps of: growing a first soot preform on a starting member by a soot deposition; dehydrating the first soot preform; sintering the first dehydrated soot preform to obtain a first glassed optical fiber perform; growing an over-clad soot layer on the first optical fiber preform by the soot deposition to obtain a second soot preform; and sintering the second soot preform to obtain a second optical fiber preform which is glassed, wherein an average density of the first soot preform is substantially within a range of 0.19˜0.30 g/cc, and the average density of the over-clad soot layer is substantially within a range of 0.5˜0.75 g/cc.

According to another embodiment of the present invention, a method for fabricating an optical fiber is provided, which includes the steps of: (a) growing a first soot preform on a starting member by a soot deposition; (b) dehydrating the first soot preform; (c) sintering the first dehydrated soot preform to obtain a first glassed optical fiber perform; (e) growing an over-clad soot layer on the first optical fiber preform by soot deposition, so as to obtain a second soot preform; (f) sintering the second soot preform to obtain a second optical fiber preform which is glassed; and (g) heating and melting an end portion of the second optical fiber preform while drawing an optical fiber, wherein an average density of the first soot preform is substantially within a range of 0.19˜0.30 g/cc, and the average density of the over-clad soot layer is substantially within a range of 0.5˜0.75 g/cc.

### BRIEF DESCRIPTION OF THE DRAWINGS

The present invention will be more apparent from the following detailed description taken in conjunction with the accompanying drawings, in which:

FIG. 1 is a flowchart illustrating a method for fabricating an optical fiber preform according to a preferred embodiment of the present invention;

FIG. 2 is a view illustrating a step for growing a first soot preform;

FIG. 3 is a view illustrating a step for dehydrating the first soot preform;

FIG. 4 is a view illustrating a step for sintering the first dehydrated soot preform;

FIG. 5 is a view illustrating a step for elongating the first optical fiber preform;

FIG. 6 is a view illustrating a step for growing an over-clad soot layer;

FIG. 7 is a view illustrating a step for sintering a second soot preform;

FIG. 8 is a view illustrating steps for drawing an optical fiber;

FIG. 9 is a graph illustrating a breakage frequency of the first optical fiber preform and a loss of the optical fiber depending on an average density of the first soot preform;

FIG. 10 is a graph illustrating a breakage frequency and an exterior crack of the second optical fiber preform depending on an average density of an over-clad layer; and

FIG. 11 is a graph illustrating a spectrum loss of an optical fiber drawn from the second optical fiber preform satisfying an optimal average density condition.

### DETAILED DESCRIPTION OF THE INVENTION

Hereinafter, an embodiment of the present invention will be described in detail with reference to the accompanying drawings. For the purposes of clarity and simplicity, a detailed description of known functions and configurations incorporated herein is omitted to avoid making the subject matter of the present invention unclear.

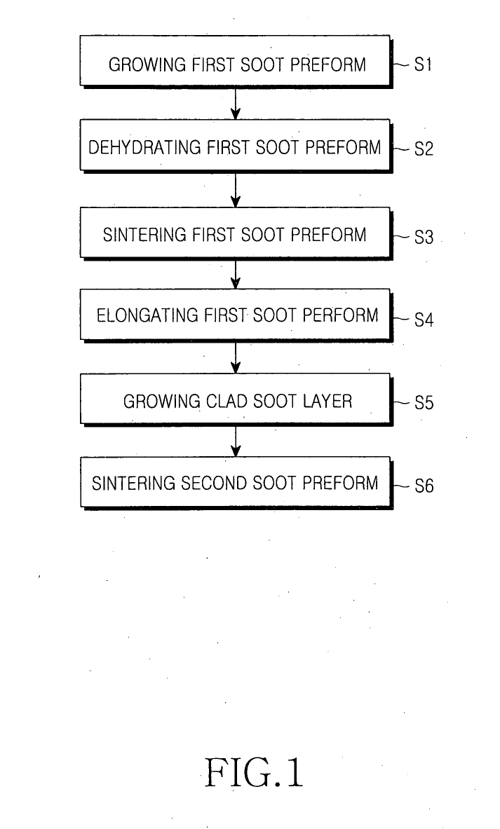

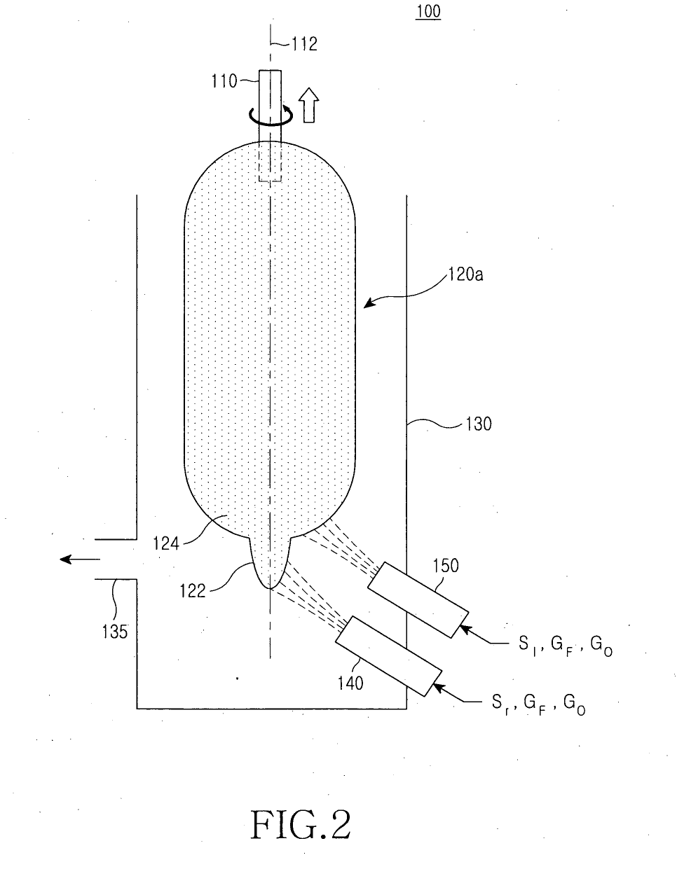

FIG. 1 is a flowchart illustrating a method for fabricating an optical fiber preform according to a preferred embodiment of the present invention. FIGS. 2 to 7 are views illustrating steps for fabricating an optical fiber preform. The method for fabricating the optical fiber preform includes steps (a), (b), (c), (d), (e) and (f) S1˜S6.

The step (a) S1 is a process for growing a first soot preform on a starting member by a soot deposition.

FIG. 2 is a view illustrating the step for growing the first soot preform. As shown in FIG. 2, an apparatus 100 for fabricating the first soot preform, includes a deposition chamber 130 and first and second burners 140 and 150.

The deposition chamber 130 has a cylinder shape with an inner space, and the deposition chamber 130 includes an exhaust port 135 at one side thereof, and the first and second burners 140 and 150 installed at the other side thereof.

In a step of preparing a starting member before the step (a) S1, the starting member 110 is installed in the deposition chamber 130. The first soot preform 120a is grown from the end portion of the starting member 110. The first soot perform 120a includes a core 122 and a clad 124. The core 122 has a relatively high refractive index. The clad 124 surrounding the core 122 has a relatively low refractive index. In the early stage of the soot deposition, the soot is deposited on the end portion of the starting member 110 by using the second burner 150, so as to form a ball. When the soot is continuously deposited until the ball has a desired size. The core 122 and the clad 124 are simultaneously formed on the ball by using the first and second burners 140 and 150. If the first soot preform 120a is directly grown on the end portion of the starting member 110 without the creation of the ball, the weight of the first soot preform 120a may cause the first soot preform 120a to separate from the starting member 110, or a crack may form thereon. During the soot deposition, the starting member 110 rotates and moves upward. The starting member 110 is rotated around the central axis 112 thereof to allow the first soot preform 120a to have a rotation symmetry. Further, the starting member 110 is moved upward along the central axis 112 thereof, thereby making the first soot preform 120a continuously grow downward. The growth direction of the first soot preform 120a on the central axis 112 of the starting member 110 is referred to as “downward”, while a reverse direction is called “upward”.

The first burner 140 is inclined at an acute angle with respect to the central axis 112 of the starting member 110 and the first burner 140 sprays flame toward the end portion of the first soot preform 120a to grow the core 122 downward from the end portion of the first soot perform 120a. The first burner 140 is provided with source materials Sᵣ, fuel gas G_{F} including hydrogen, and oxide gas G_{O} including oxygen. The source materials Sᵣ include a glass forming material such as SiCl₄ and a refractive index control material such as GeCl₄, POCl₃, or BCl₃. The source materials Sᵣ are dissolved by hydrolysis in the flame sprayed from the first burner 140 so as to form the soot. Then the created soot is deposited on the core 122 of the first soot preform 120a.

The hydrolysis relating to SiO₂ and GeO₂, which are main oxides constructing the soot, is expressed by following chemical formulas (1) and (2).

SiCl₄+2H₂+O₂→SiO₂+4HCl (1)

GeCl₄+2H₂→GeO₂+4HCl (2)

The second burner 150 is disposed over and spaced apart from the first burner 140. The second burner 150 has a central axis inclined at an acute angle with respect to the central axis 112 of the starting member 110. The second burner 150 sprays flame toward an outer peripheral surface of the core 122 to grow a clad 124 on the outer peripheral surface of the core 122. The second burner 150 is provided with source materials Sₗ, fuel gas G_{F} including hydrogen, and oxide gas G_{O} including oxygen. The source materials Sₗ include a glass forming material such as SiCl₄ and an additive material such as CF₄ or C₂F₆. The source materials Sₗ are dissolved by hydrolysis in the flame sprayed from the second burner 150 so as to generate soot. The generated soot is deposited on the clad 124 of the first soot preform 120a.

The quantity and the kinds of the source material Sᵣ supplied to the first burner 140 and the source material Sₗ supplied to the second burner 150 are differently/separately controlled. In this manner, the core 122 has a higher refractive index than that of the clad 124. For example, germanium and phosphorus increase the refractive index, while boron decreases the refractive index. Among the soot generated by the first and second burners 140 and 150, the residual soot that is not deposited on the first soot preform 120a is discharged outside through the exhaust port 135 of the deposition chamber 130.

An average density of the first soot preform 120a is maintained substantially within a range of 0.19˜0.30 g/cc, preferably substantially within a range of 0.20˜0.26 g/cc. The average density of the first soot preform 120a is obtained by dividing weight by volume of the first soot preform 120a.

The step (b) S2 is a process for dehydrating the first soot preform 120a.

Specifically, moisture and OH radicals existing in the first soot preform 120a are removed.

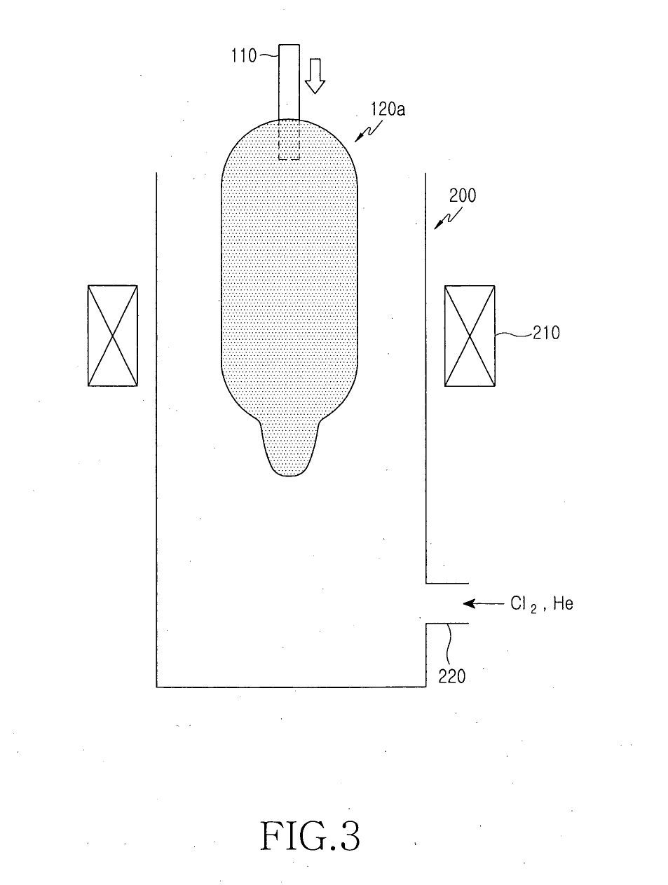

FIG. 3 is a view illustrating a step for dehydrating the first soot preform 120a. As shown in FIG. 3, a furnace 200 includes a heater 210 disposed on a wall thereof, and an inlet 220 provided to a lower portion thereof.

In a step of preparing the first soot preform 120a before the step (b) S2, the first soot preform 120a is disposed in the furnace 200. Chlorine gas (Cl₂) and helium gas (He) are supplied through the inlet 220 to the inside of the furnace 200. The temperature of the heater 210 is maintained at 1100˜1200° C. Specifically, the first soot preform 120a is heated to a temperature of 1100˜1200° C. under an atmosphere of chlorine gas and dehydrated.

The step (c) S3 is a process for sintering the first dehydrated soot preform 120a to obtain a first optical fiber preform, which is glassed.

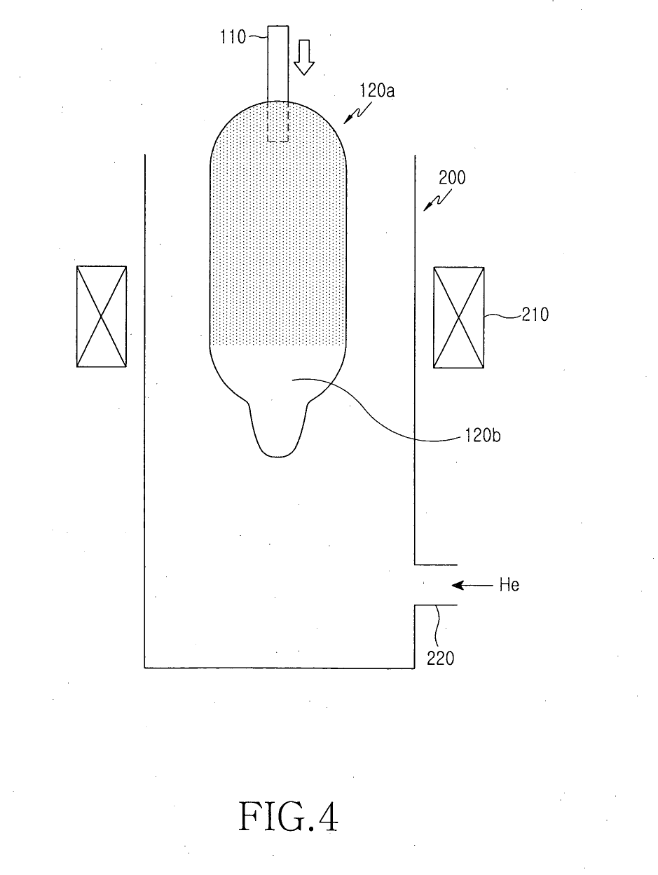

FIG. 4 is a view illustrating a step for sintering the first dehydrated soot preform 120a using the furnace (200) shown in FIG. 3. In the state that the first dehydrated soot preform 120a is disposed in the furnace 200, helium gas (He) is supplied through the inlet 220 to the inside of the furnace 200. Then, the temperature of the heater 210 is maintained at 1450˜1600° C. The first dehydrated soot preform 120a is moved downward so that the first dehydrated soot preform 120a passes through a high temperature region formed by the heater 210 in the furnace 200 (from a lower end portion to an upper end portion thereof). As a result, it is possible to obtain the first optical fiber preform 120b that is glassed. Specifically, the first opaque soot preform 120a is transformed into the first transparent optical fiber preform 120b by the sintering process. Since the helium gas has a high thermal conductivity, it is possible to uniformly transfer heat to the inside of the first soot preform 120a.

The step (d) S4 is a process for elongating the first optical fiber preform 120b. Specifically, the first optical fiber preform 120b is elongated in order to reduce the diameter and elongate the length of the first optical fiber preform 120b. In consideration of a ratio of the core to the clad of the resulting optical fiber, the first optical fiber preform 120b is elongated to have a desired diameter.

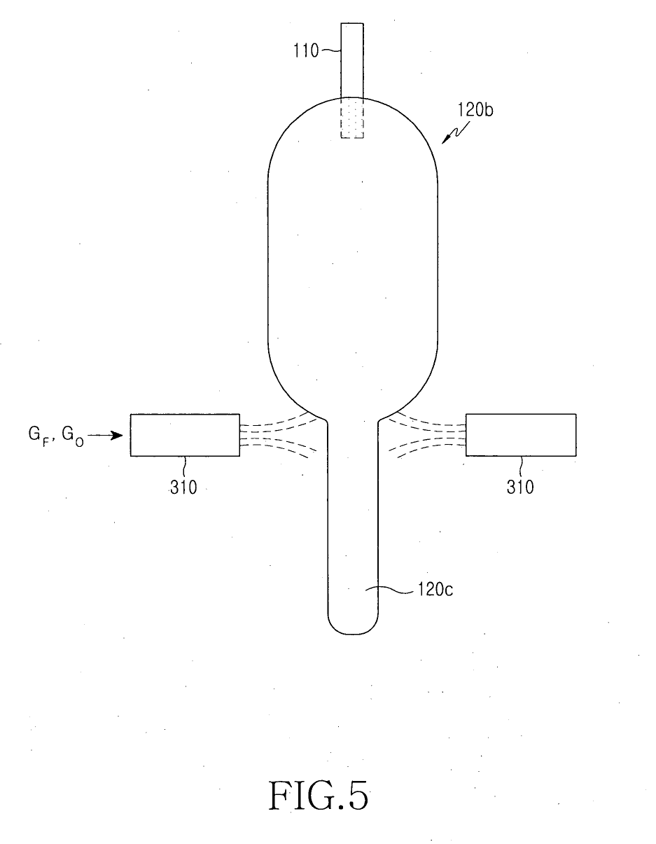

FIG. 5 is a view illustrating a step for elongating the first optical fiber preform 120b. The first optical preform 120b is heated by using a heater 310. When the first optical fiber preform 120b is softened by heating, it is possible to elongate the first optical fiber preform 120b with a desired length and diameter.

Hereinafter, the first elongated optical fiber preform 120c with a constant diameter is cut to a desired length. A dummy rod is attached to one end of the first cut optical fiber preform 120c.

The step (e) S5 is a process for growing an over-clad soot layer on the first cut optical fiber preform 120c by a soot deposition to obtain a second soot preform.

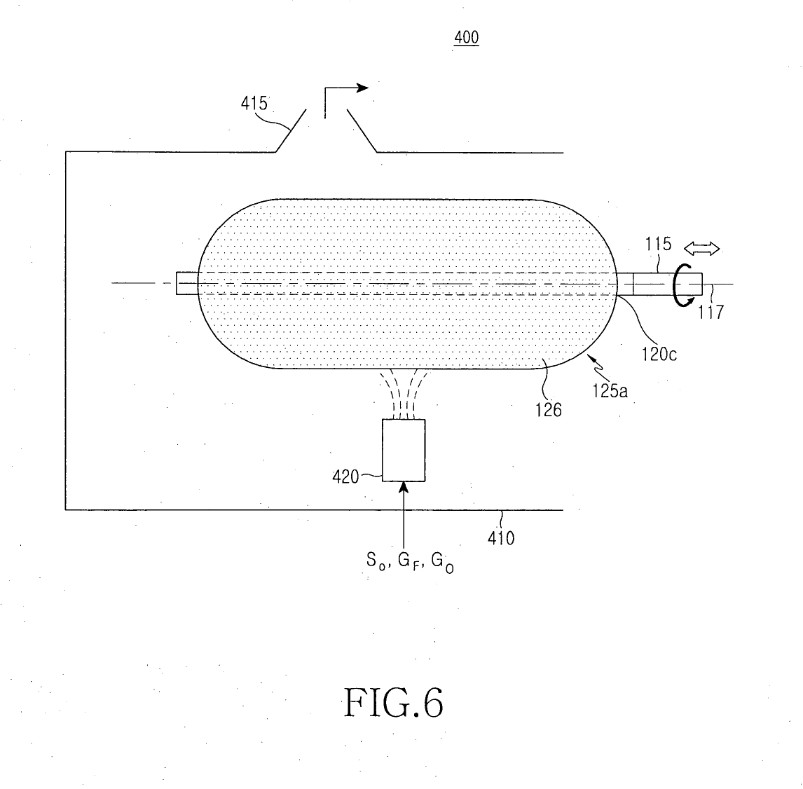

FIG. 6 is a view illustrating a process for growing the over-clad soot layer. As shown in FIG. 6, the apparatus 400 for fabricating the second soot preform includes a deposition chamber 410 and a burner 420. In a preparing step before the step (e) S5, the first optical fiber preform 120c having the dummy rod 115 attached thereto is contained in the deposition chamber 410.

The deposition chamber 410 has a cylinder shape with an inner space, and an exhaust outlet 415 formed at a side thereof. The burner 420 is aligned with the exhaust outlet 415. The first optical preform 120c is disposed between the burner 420 and the exhaust outlet. The over-clad soot layer 126 is radially grown by the soot deposition on the outer peripheral surface of the first optical fiber preform 120c. During the soot deposition, the first optical fiber preform 120c rotates. The first optical fiber preform 120c is rotated around a central axis 117 thereof so that the second soot perform 125a has a rotation symmetry. Further, the first optical fiber preform 120c is repeatedly reciprocated along a central axis 117 thereof, thereby obtaining the second soot preform 125a.

The burner 420 is provided with a source material Sₒ, which is a material to form glass, fuel gas G_{F} including hydrogen, and oxide gas G_{O} including oxygen. The source material Sₒ, for example SiCl₄, is dissolved by hydrolysis in the flame sprayed from the burner 420 to form the soot. Then the created soot is deposited on the outer peripheral surface of the first optical fiber preform 120c. Among the soot created by the burner 420, the residual soot that is not deposited on the outer peripheral surface of the first optical fiber preform 120c is discharged through the exhaust outlet 415 of the deposition chamber 410.

Alternatively, the burner 420, instead of the first optical fiber preform 120c, can be repeatedly reciprocated along the central axis 117.

An average density of the over-clad soot layer 126 is preferably maintained substantially within a range of 0.5˜0.75 g/cc. This range fosters a reduction in the breakage frequency of the second soot preform 125a and improves quality of appearance of a second optical fiber preform obtained from the second soot preform 125a. The average density of the over-clad soot layer is obtained by dividing a weight by a volume thereof.

The step (f) S6 is a process for sintering the second soot preform 125a and obtaining the second optical fiber perform that is glassed.

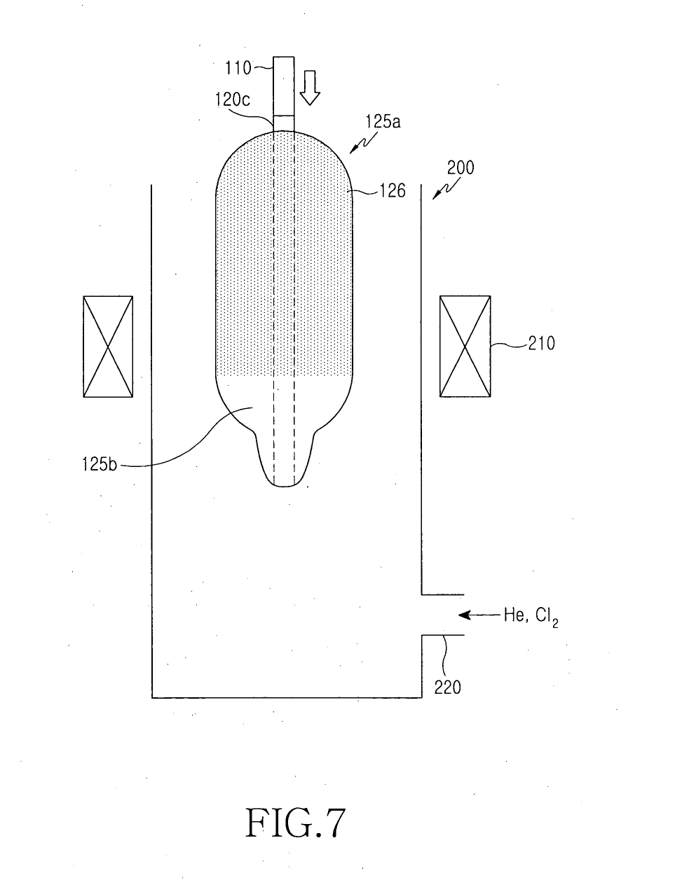

FIG. 7 is a view illustrating a process of sintering the second soot preform 125a using the furnace 200 as shown in FIG. 4. In the state that the second soot preform 125a is contained in the furnace 200, helium gas and chlorine gas are supplied through the inlet 220 to the inside of the furnace 200. The temperature of the heater 210 is maintained between 1450˜1600° C. The second soot preform 125a is moved downward so that the second soot preform 125a passes through a high temperature region formed by the heater 210 in the furnace 200 (from a lower end portion to an upper end portion thereof). As a result, it is possible to obtain the second optical fiber preform 125b that is glassed. Specifically, the second opaque soot preform 125a is transformed into the second transparent optical fiber preform 125b by the sintering process.

Hereinafter, the second optical fiber preform 125b fabricated by the above method is drawn as an optical fiber through a process described below. The core 122 and the clad 124 of the first soot preform 120a and the over-clad soot layer 126 correspond to a core, an inner clad, and an outer clad of the second optical fiber preform, respectively. The optical fiber has a similar structure as that of the second optical fiber preform 125b.

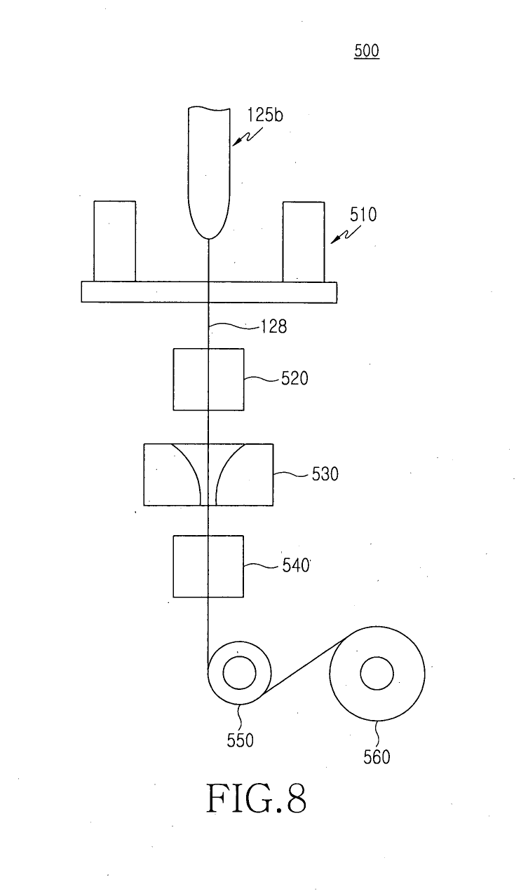

FIG. 8 is a view illustrating a step of drawing the optical fiber. As shown in FIG. 8, the drawing apparatus 500 includes a furnace 510, a cooler 520, a coater 530, an ultraviolet hardener 540, a capstan 550, and a spool 560.

The furnace 510 has a cylindrical shape with an inner space. The furnace 510 heats an end portion of the second optical fiber preform 125b that is disposed therein, to 2200˜2300° C., and melts it. The optical fiber 128, which is drawn from the second optical fiber preform 125b, has a similar structure to the second optical fiber preform 125b, but has a greatly smaller diameter than that of the second optical fiber preform 125b. In order to prevent the inside of the furnace 510 from being oxidized, inert gas is allowed to flow within the furnace 510.

The cooler 520 cools the heated optical fiber 128 that is drawn from the furnace 510.

The coater 530 coats an ultraviolet-cured resin on the optical fiber 128 that passes through the cooler 520. The ultraviolet hardener 540 emits ultraviolet rays to the ultraviolet-cured resin to harden the ultraviolet-cured resin.

The capstan 550 pulls the optical fiber 128 with a predetermined force, and continuously draws the optical fiber 128 from the second optical fiber preform 125b. The optical fiber 128 has a constant diameter.

After passing through the capstan 550, the optical fiber 128 is wound on the spool 560.

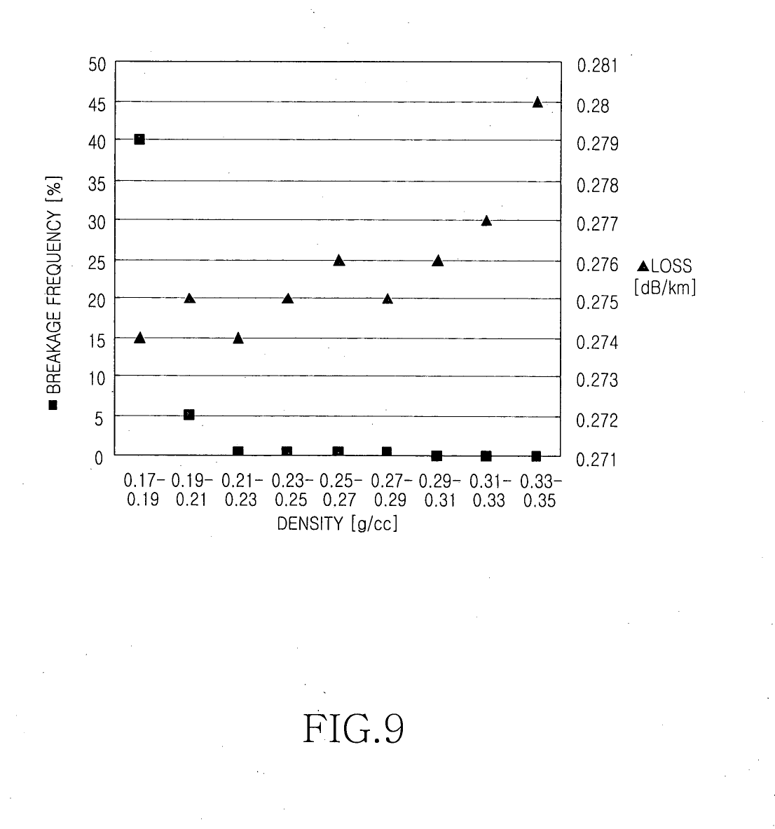

FIG. 9 is a graph illustrating a breakage frequency of the first soot preform and a loss of the optical fiber depending on the average density of the first soot preform. FIG. 9 shows the breakage frequency, represented by “▪” of the first soot preform 120a and the loss distribution, represented by “▴” of the optical fiber 128 depending on the average density of the first soot preform 120a. In FIG. 9, the average density of the first soot preform 120a is indicated on a transverse axis. The breakage frequency of the first soot preform 120a is indicated on a left longitudinal axis. The loss of OH radical absorption of the optical fiber 128 with relation to the light with a wavelength of 1383 nm is denoted on a right longitudinal axis. As shown in FIG. 9, the breakage frequency rapidly increases when the average density of the first soot preform 120a is less than 0.19 g/cc. This indicates that the first soot preform 120a can be easily broken by small external impact. This is because attraction of SiO₂ particles is weakened as the average density of the first soot preform 120a decreases. Further, stress, which is applied to the first soot preform 120a by the shrinkage of the first soot preform 120a during cooling of the first heated soot preform 120a, may cause the breakage of the first soot preform 120a. As shown in FIG. 9, it is understood that when the average density of the first soot perform 120a is equal to or greater than 0.20 g/cc, the breakage frequency is reduced. On the other hand, where the average density of the first soot preform 120a is equal to or greater than 30 g/cc, the loss of the OH radical absorption of the optical fiber 128 increases.

Therefore, the optimal range of the average density of the first soot preform 120a, in which the breakage frequency of the first soot preform 120a and the loss of the OH radical absorption of the optical fiber 128 can be simultaneously reduced, is 0.19˜0.30 g/cc, preferably 0.20˜0.26 g/cc.

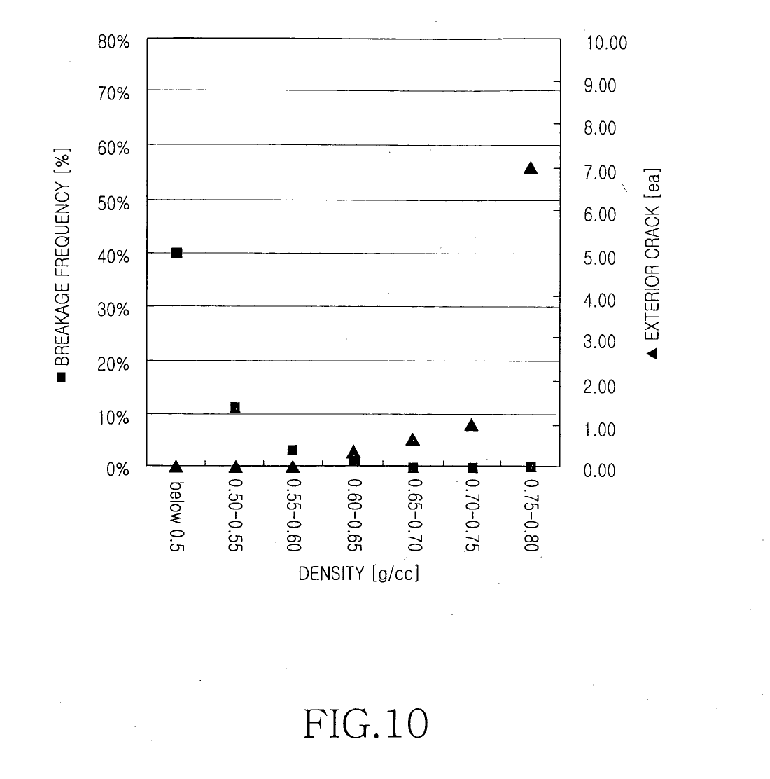

FIG. 10 is a graph illustrating a breakage frequency of the second soot preform and exterior cracks of the second optical fiber preform depending on the average density of the over-clad soot layer. FIG. 10 shows the breakage frequency, represented by “▪” of the second soot preform 125a and the number of the exterior cracks, represented by “▴” formed on the second optical fiber preform 125b. In FIG. 10, the average density of the over-clad soot layer 126 is indicated on a transverse axis. The breakage frequency of the second soot preform 125a is indicated on a left longitudinal axis. The number of exterior cracks of the second optical fiber preform 125b is denoted on a right longitudinal axis. As shown in FIG. 10, the breakage frequency of the second soot preform 125a rapidly increases when the average density of the over-clad layer 126 is less than 0.5 g/cc. Further, when the average density of the over-clad soot layer 126 exceeds 0.75 g/cc, crystals with a specific shape may be formed on the second optical fiber preform 125b. This is because a surface of the over-clad layer 126 becomes uneven due to overheating of the over-clad soot layer 126 during growth of the over-clad soot layer 126. The uneven surface of the over-clad layer 126 develops into the exterior cracks during sintering of the over-clad layer 126. If the exterior cracks have a size exceeding 3mm, breaking of the optical fiber 128 can be induced during the drawing of the optical fiber 128.

Therefore, the optimal range of the average density of the over-clad layer 126 is 0.5˜0.75 g/cc, preferably 0.55˜0.7 g/cc. In this range, the breakage frequency of the second soot preform 125a and the number of the exterior cracks of the second optical fiber preform 125b can be simultaneously reduced.

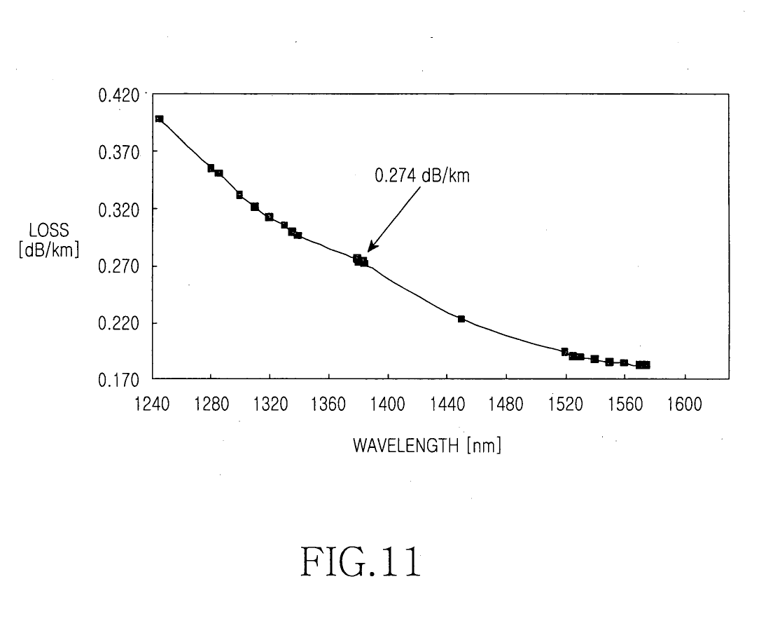

FIG. 11 is a graph illustrating a spectrum loss of an optical fiber that is drawn from the second optical fiber preform satisfying a condition of the optimal average density. As illustrated in FIG. 11, the loss of the OH radical absorption of the optical fiber 128 with relation to a light with a wavelength of 1383 nm is about 0.274 dB/km.

In the method for fabricating the optical fiber preform and the method for fabricating the optical fiber using the optical fiber preform, according to the present invention, the optimal average density of the first soot preform is maintained. This, in turn, reduces the breakage frequency of the first soot preform and the loss of the OH radical absorption of the optical fiber. Thus, it is possible to reduce the cost of fabricating the optical fiber preform, improve the quality of the optical fiber preform, and stably mass-produce a low water peak optical fiber. Further, the optimal average density of the over-clad soot layer can be maintained, thereby reducing the breakage and exterior cracks, resulting in the reduction of the cost of fabricating the optical fiber preform, and the improvement of the quality of the optical fiber.

While the invention has been shown and described with reference to a certain preferred embodiment thereof, it will be understood by those skilled in the art that various changes in form and details may be made therein without departing from the spirit and scope of the invention as defined by the appended claims. For example, when a specific range is provided, one skilled in art will recognize that ranges not substantially within such a range may only provide some of the advantages of the present invention.

What is claimed is:

1. A method for fabricating an optical fiber preform, the method comprising the steps of:
(a) growing a first soot preform on a starting member by a soot deposition;
(b) dehydrating the first soot preform; and
(c) sintering the first dehydrated soot preform to obtain a first glassed optical fiber perform,
wherein an average density of the first soot preform is substantially within a range of 0.19˜0.30 g/cc.

2. The method as claimed in claim 1, further comprising the steps of:
(e) growing an over-clad soot layer on the first optical fiber preform by the soot deposition to obtain a second soot preform; and
(f) sintering the second soot preform to obtain a second optical fiber preform that is glassed.

3. The method as claimed in claim 2, wherein the average density of the over-clad soot layer is substantially within a range of 0.5˜0.75 g/cc.

4. The method as claimed in claim 2, further comprising a step of (d) elongating the first optical fiber perform between step (c) and step (e), wherein the step (e) is performed with relation to the first elongated optical fiber preform.

5. The method as claimed in claim 1, wherein the average density of the first soot preform is substantially within a range of 0.20˜0.26 g/cc.

6. A method for fabricating an optical fiber preform, comprising the steps of:
(a) growing a first soot preform on a starting member by a soot deposition;
(b) dehydrating the first soot preform;
(c) sintering the first dehydrated soot preform to obtain a first glassed optical fiber perform;
(e) growing an over-clad soot layer on the first optical fiber preform by the soot deposition to obtain a second soot preform; and
(f) sintering the second soot preform so as to obtain a second optical fiber preform that is glassed,
wherein an average density of the first soot preform is substantially within a range of 0.19˜0.30 g/cc, and the average density of the over-clad soot layer is substantially within a range of 0.5˜0.75 g/cc.

7. The method as claimed in claim 6, wherein the average density of the first soot preform is substantially within a range of 0.20˜0.26 g/cc.

8. The method as claimed in claim 6, further comprising a step of (d) elongating the first optical fiber perform between step (c) and step (e), wherein the step (e) is performed with relation to the first elongated optical fiber preform.

9. A method for fabricating an optical fiber, the method comprising the steps of:
(a) growing a first soot preform on a starting member by a soot deposition;
(b) dehydrating the first soot preform;
(c) sintering the first dehydrated soot preform to obtain a first glassed optical fiber perform;
(e) growing an over-clad soot layer on the first optical fiber preform by soot deposition to obtain a second soot preform;
(f) sintering the second soot preform to obtain a second optical fiber preform which is glassed; and
(g) heating and melting an end portion of the second optical fiber preform while drawing an optical fiber,
wherein an average density of the first soot preform is substantially within a range of 0.19˜0.30 g/cc, and the average density of the over-clad soot layer is substantially within a range of 0.5˜0.75 g/cc.

10. The method as claimed in claim 9, wherein the average density of the first soot preform is substantially within a range of 0.20˜0.26 g/cc.

11. The method as claimed in claim 6, further comprising a step of (d) elongating the first optical fiber perform between step (c) and step (e), wherein the step (e) is performed with relation to the first elongated optical fiber preform.
